(19) United States
(12) Patent Application Publication
(10) Pub. No.: US 2025/0279649 A1
(43) Pub. Date: Sep. 4, 2025

(54) SYSTEMS AND METHODS FOR WORKSITE DYNAMIC CHARGING

(71) Applicant: Caterpillar Inc., Peoria, IL (US)

(72) Inventors: Srideep Chatterjee, Bhopal (IN); L S N V A Vinaykumar Gullapudi, Koyyalagudem (IN); Prakash Prashanth Ravi, Bangalore (IN)

(73) Assignee: Caterpillar Inc., Peoria, IL (US)

(21) Appl. No.: 18/592,761

(22) Filed: Mar. 1, 2024

(51) Int. Cl. H02J 3/16; H02J 3/32; H02J 3/38; H02J 7/00

(52) U.S. Cl. CPC H02J 3/16; H02J 3/32; H02J 3/38; H02J 7/00032; H02J 7/0047; H02J 7/0071

(57) ABSTRACT

At least one aspect of the present disclosure is directed to a system, method, or a computer-readable medium of the following. A method can include one or more processors receiving information indicative of load metrics relating to a power grid. The method can include the one or more processors identifying metrics for a plurality of charging machines to be charged at the worksite. The method can include the one or more processors determining a charging rate for a charging machine at the worksite, for each charging machine of the plurality of charging machines, according to the metrics and load metrics of the power grid. The method can include the one or more processors controlling a plurality of chargers at the worksite, according to the charging rate associated with a corresponding charging machine.

### TECHNICAL FIELD

The present implementations relate generally to dynamic charging, and more particularly to worksite dynamic charging.

### INTRODUCTION

The present disclosure relates generally to dynamic charging, and more particularly to worksite dynamic charging. Worksites, such as construction sites, manufacturing plants, mining sites, and/or agricultural sites, may require machines to charge various components/hardware/vehicles on or at the worksite.

### SUMMARY

This disclosure is generally directed to worksite dynamic charging. With the introduction of electrified machines in a worksite, there is an increase of vehicle to vehicle charging and vehicle to grid charging. The process of vehicle to vehicle charging and vehicle to grid charging at a worksite can raise issues of compatibility, because of the different charging requirements of different machines. The process can reduce productivity, increase energy demand, raise scheduling issues, increase project timelines and increase cost to maintain a higher charging infrastructure. Aspects of this technical solution can provide a method for worksite dynamic charging to improve productivity, reduce compatibility issues, reduce energy demand, reduce scheduling issues, and reduce the cost of the charging infrastructure. For example, using worksite dynamic charging allows for a method that can include receiving information indicative of load metrics relating to a power grid. The method can include identifying metrics for a plurality of charging machines to be charged at a worksite. The method can include determining, for each charging machine of the plurality of charging machines, a charging rate for the charging machine at the worksite, according to the metrics and the load metrics of the power grid. The method can include controlling a plurality of chargers at the worksite, according to the charging rate associated with a corresponding charging machine.

A first aspect provided herein relate to a method of dynamic charging at a worksite. The method can include one or more processors receiving information indicative of load metrics relating to a power grid. The method can include the one or more processors identifying metrics for a plurality of charging machines to be charged at the worksite. The method can include the one or more processors determining a charging rate for a charging machine at the worksite, for each charging machine of the plurality of charging machines, according to the metrics and load metrics of the power grid. The method can include the one or more processors controlling a plurality of chargers at the worksite, according to the charging rate associated with a corresponding charging machine.

In some embodiments, the information indicative of the load metrics is received from the plurality of chargers and from a grid controller associated with the power grid. In some embodiments, the load metrics can include one or more measurements corresponding to a demand in power at the worksite. In some embodiments, the demand can include an increase in power at the worksite or a decrease in power at the worksite.

In some embodiments, the charging rate for the charging machine can include a negative charging rate. In some embodiments, the method can include controlling the charger according to the negative charging rate can include discharging the corresponding charging machine to the power grid. In some embodiments, the power grid can include a microgrid. In some embodiments, the one or more processors are of a worksite controller. In some embodiments, the method can include transmitting, by the one or more processors of the worksite controller, one or more signals to a charge/discharge controller, to cause the charge/discharge controller to transmit one or more signals to the plurality of charging machines.

In some embodiments, the method can include transmitting, by the charge/discharge controller, one or more signals to the plurality of chargers. In some embodiments, the one or more signals can include to charge the charging machine or discharge the charging machine. In some embodiments, the method can include determining, by the worksite controller, the charging rate for the charging machine at the worksite, based on a renewable availability from the microgrid. In some embodiments, the renewable availability including at least one of wind turbines, photovoltaic (PV) panels, generator sets, or hydropower and determining, by the worksite controller, the charging rate for the charging machine at the worksite, based on an efficiency metric for the microgrid to maximize the efficiency of the microgrid.

In some embodiments, the method can include determining a charging rate for the charging machine at the worksite further comprising receiving, by the one or more processors, battery metrics of the charging machine. In some embodiments, the battery metrics can include at least one of a state of charge, a state of health, a voltage, charging time, or safety parameters. In some embodiments, the method can include receiving, by the one or more processors, a schedule. In some embodiments, the schedule can include one or more gaps in operation of the charging machines.

A first aspect provided herein relate to a system of dynamic charging at a worksite. The system can include memory and one or more processors that can receive information indicative of load metrics relating to a power grid. The one or more processors can identify metrics for a plurality of charging machines to be charged at a worksite. The one or more processors can determine for each charging machine of the plurality of charging machines, a charging rate for the charging machine at the worksite, according to the metrics and the load metrics of the power grid. The one or more processors can control a plurality of chargers at the worksite, according to the charging rate associated with a corresponding charging machine.

In some embodiments, the information indicative of the load metrics is received from the plurality of chargers and from a grid controller associated with the power grid. In some embodiments, the load metrics can include one or more measurements corresponding to a demand in power at the worksite. In some embodiments, the demand can include an increase in power at the worksite or a decrease in power at the worksite.

In some embodiments, the charging rate for the charging machine can include a negative charging rate. In some embodiments, to control the charger according to the negative charging rate, the one or more processors are configured to discharge the corresponding charging machine to the power grid. In some embodiments, the metrics for the plurality of charging machines can include one or more measurements corresponding to a supply of charge with the corresponding charging machine.

In some embodiments, the power grid can include a microgrid. In some embodiments, the one or more processors are of a worksite controller. In some embodiments, the worksite controller is configured to transmit one or more signals to a charge/discharge controller, to cause the charge/discharge controller to transmit one or more signals to the plurality of charging machines. In some embodiments, the charge/discharge controller is configured to transmit one or more signals to the plurality of chargers. In some embodiments, the one or more signals can include charge the charging machine or discharge the charging machine.

In some embodiments, the worksite controller is configured to determine the charging rate for the charging machine at the worksite, based on a renewable resource availability from the microgrid. In some embodiments, the renewable resource availability can include at least one of wind turbines, photovoltaic (PV) panels, generator sets, or hydropower determine the charging rate for the charging machine at the worksite, based on an efficiency metric for the microgrid to maximize efficiency of the microgrid.

In some embodiments, the one or more processors are configured to receive battery metrics of the charging machine. In some embodiments, the battery metrics indicate at least one of a state of charge, a state of health, a voltage, charging time, or safety parameters and receive a schedule. In some embodiments, the schedule indicates one or more gaps in operation of the charging machines. In some embodiments, the gap is a period of time in which the charging machine is not in use at the worksite.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1 depicts an example system to implement worksite dynamic charging at a worksite, in accordance with present implementations.

FIG. 2 depicts example sections of the worksite and a microgrid, in accordance with present implementations.

FIG. 3 depicts an example layout of the worksite, in accordance with present implementations.

FIG. 4 depicts an example data processing system for to implement worksite dynamic charging, in accordance with present implementations.

FIG. 5 depicts an example flow diagram for power quality support for the worksite and a microgrid, in accordance with present implementations.

FIG. 6 depicts an example flow diagram for optimization of charging for the worksite and the microgrid, in accordance with present implementations.

FIG. 7 depicts a method to implement worksite dynamic charging for the worksite and microgrid, in accordance with present implementations.

### DETAILED DESCRIPTION

This disclosure is generally directed to a method for worksite dynamic charging to increase efficiency while reducing costs at a worksite. With the introduction of electrified machines in a worksite, there is an increase of vehicle to vehicle charging and vehicle to grid charging. The process of vehicle to vehicle charging and vehicle to grid charging at a worksite can raise issues of compatibility, because of the different charging requirements of different machines. The process can reduce productivity, increase energy demand, raise scheduling issues, increase project timelines and increase cost to maintain a higher charging infrastructure at the worksite. Aspects of this technical solution can provide a method for worksite dynamic charging to improve productivity, reduce compatibility issues, reduce energy demand, reduce scheduling issues, and reduce the cost of the charging infrastructure. For example, using worksite dynamic charging allows for a method that can include receiving information indicative of load metrics relating to a power grid. The method can include identifying metrics for a plurality of charging machines to be charged at a worksite. The method can include determining for each charging machine of the plurality of charging machines, a charging rate for the charging machine at the worksite, according to the metrics and the load metrics of the power grid. The method can include controlling a plurality of chargers at the worksite, according to the charging rate associated with a corresponding charging machine.

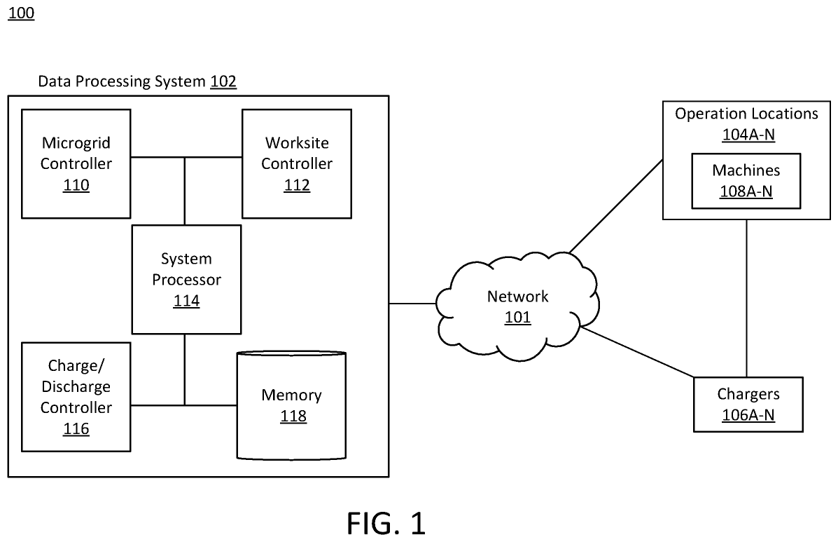

FIG. 1 depicts an example system 100 to implement worksite dynamic charging at a worksite. The system 100 can include a data processing system 102, operation locations 104A-N (referred to as operation locations 104 herein), and chargers 106A-N (referred to as chargers 106 herein). The above-mentioned components may be connected to each other through a network 101. The examples of the network 101 may include, but are not limited to, cellular (e.g., 3G, 4G, LTE, 5G, etc.) network, private or public local area network (LAN), wireless-LAN (WLAN), metropolitan area network (MAN), wide area network (WAN), and so forth, which may be used for communicating (e.g., via the Internet) with various endpoints. The network 101 may include both wired and wireless communications according to one or more standards and/or via one or more transport mediums.

The communication over the network 101 may be performed in accordance with various communication protocols such as Transmission Control Protocol and Internet Protocol (TCP/IP), User Datagram Protocol (UDP), and IEEE communication protocols. In one example, the network 101 may include wireless communications according to Bluetooth specification sets, or another standard or proprietary wireless communication protocol. In another example, the network 101 may also include communications over a cellular network, including, e.g., a GSM (Global System for Mobile Communications), CDMA (Code Division Multiple Access), EDGE (Enhanced Data for Global Evolution) network.

The system 100 is not confined to the components described herein and may include additional or alternate components, not shown for brevity, which are to be considered within the scope of the embodiments described herein.

The system 100 can include at least one data processing system 102. The data processing system 102 can include a physical computer system operatively coupled or that can be coupled with one or more components of the system 100, either directly or through an intermediate computing device or system. The data processing system 102 can include a virtual computing system, an operating system, and/or a communication bus to effect communication and processing. The data processing system 102 can include a microgrid controller 110, a worksite controller 112, a system processor 114, a charge/discharge controller 116, and memory 118.

The system 100 can include at least memory 118 within the data processing system 102. The memory 118 can be coupled to the microgrid controller 110, the worksite controller 112, the system processor 114, and the charge/discharge controller 116. The memory 118 can store data associated with the system 100. The memory 118 can include one or more hardware memory devices to store binary data, digital data, or the like. The memory 118 can include one or more electrical components, electronic components, programmable electronic components, reprogrammable electronic components, integrated circuits, semiconductor devices, flip flops, arithmetic units, or the like. The memory 118 can include at least one of a non-volatile memory device, a solid-state memory device, a flash memory device, and a NAND memory device. The memory 118 can include one or more addressable memory regions disposed on one or more physical memory arrays. A physical memory array can include a NAND gate array disposed on, for example, at least one of a particular semiconductor device, integrated circuit device, or printed circuit board device.

The microgrid controller 110, the worksite controller 112, the system processor 114, and the charge/discharge controller 116 (referred to as the controllers) can execute one or more instructions associated with the data processing system 102. The controllers can include an electronic processor, an integrated circuit, or the like including one or more of digital logic, analog logic, digital sensors, analog sensors, communication buses, volatile memory, nonvolatile memory, and the like. The controllers can include, but are not limited to, at least one microcontroller unit (MCU), microprocessor unit (MPU), central processing unit (CPU), graphics processing unit (GPU), physics processing unit (PPU), embedded controller (EC), or the like. The controllers can include memory operable to store or storing one or more instructions for operating components of the processors and operating components operably coupled to the controllers. For example, the one or more instructions can include one or more of firmware, software, hardware, operating systems, embedded operating systems. The controllers or the data processing system 102 generally can include one or more communication bus controllers to effect communication between the controllers and the other elements of the data processing system 102.

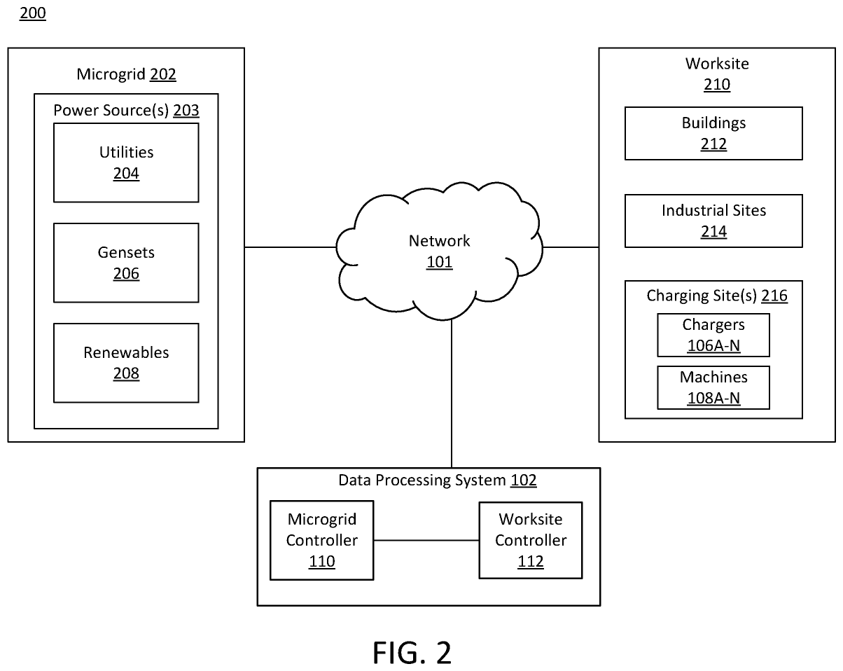

Referring to FIG. 1 and FIG. 2, FIG. 2 depicts example sections 200 of the worksite 210 and a microgrid 202. The worksite controller 112 can be configured to receive information indicative of load metrics relating to a power grid (or utilities 204). The power grid can be an electrical grid or microgrid, with a plurality of interconnected electrical components (e.g., wires, capacitors, inductors, resistors, transformers) to facilitate the generation and distribution of electricity. For example, the power grid may be electrically connected to a power plant that generates electricity, to distribute the power to various service drops or endpoints. Using one or more transmission lines, the power grid can distribute the electricity to one or more chargers 106. The information indicative of load metrics can include electricity generation data, load data, voltage data, transmission line data, fault data, or weather data. The information can be used to form the load metrics. For example, a worksite controller 112 can receive electricity generation data. In another example, a worksite controller 112 can receive load data and fault data. In yet another example, a worksite controller 112 can receive transmission line data, electricity generation data, and fault data.

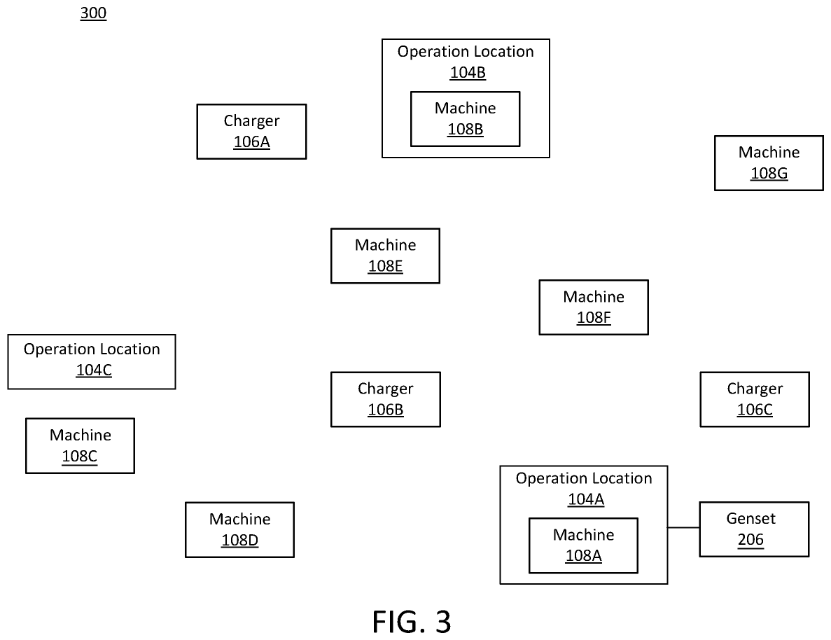

The system 100 can include at least one charger 106 at a worksite 210. The worksite can include one or more operation locations 104. The operation location 104 can be a specific area within the worksite 210 where a plurality of activities corresponding to the work environment take place. For example, at a construction site, an operation location 104 can be an excavation site or a building assembly site. In another example, at mining site, an operation location 104 can be an area or location where mineral/material/fluids/ore extraction occurs. Each operation location 104 can include one or more machines 108A-N (referred to as machines 108 herein). For example, referring briefly to FIG. 3, operation location 104A can include machine 108A, operation location 104B can include machine 108B, and the worksite 300 can generally include chargers 106A-106C and machines 108C-108G displaced or positioned throughout the worksite 300.

Referring still to FIG. 1 and FIG. 2, the section 200 may include a microgrid 202. The microgrid 202 may be or include a localized or contained power grid dedicated for a particular region. The microgrid 202 may include various power sources 203 which supply power to the microgrid for distribution in the localized/contained area. For example, the microgrid 202 may include power sources 203, including utilities 204, generator sets 206, and renewable power sources 208. Various combinations of such power sources 203 can supply power to the microgrid 202, to supply power to the localized/contained area (such as the worksite 210).

The power sources 203 which supply power to the microgrid 202 may include utilities 204. The utilities 204 may be or include a power source or connector corresponding to a utility line (e.g., a line/service drop from the power grid) supplying power generated for distribution across a wide power grid. The power of the utilities can be supplied by a power plant (e.g., solar power plant, hydroelectric power plant, or wind power plant, among others). The power plants can be owned or operated by an energy company, to supply power to the worksite 210. For example, the power plant can supply power through a utility line of the utilities 204, and the utilities 204 can provide the power to the microgrid 202.

The power sources 203 which supply power to the microgrid 202 may include generator sets 206 (referred to as “gensets 206” herein). The gensets 206 may be located within close proximity to the operation locations 104, chargers 106, and/or areas of high power consumption. The gensets 206 may include backup generators, distributed energy resources (DERs), or portable generators among others. For example, as shown in FIG. 3, a genset 206 may be located next to an operation location 104A to supply power directly to the machines 108 at the operation location 104A. In another example, the gensets 206 may be located next to one or more chargers 106 to supply power directly to the one or more chargers 106.

The power sources 203 which supply power to the microgrid 202 may include renewable energy sources (referred to as “renewables 208” herein). The renewables 208 can include solar power, wind power, hydropower, geothermal power, wave energy, or biomass energy, communicably coupled to a power store configured to store power sourced from such renewable energy sources. The renewables 208 can naturally generate power over time and are sustainable, and have a lower environmental impact. The renewables 208 can receive energy from solar farms, wind turbines, water damns, geothermal power plants, or wave energy converters, among others. For example, a solar farm can supply power in the form of solar energy to the microgrid 202. In another example, wind turbines can supply power in the form of wind energy to the microgrid 202.

The worksite 210 can include one or more buildings 212. The buildings 212 may be associated with the worksite 210. For example, an excavation worksite 210 can include one or more control buildings 212 to monitor and control complex processes related to production and energy consumption. The worksite 210 can include one or more industrial sites 214. The industrial sites 214 can be a specific area of the worksite 210 relating to manufacturing, production, or processing at the worksite 210. For example, an industrial site 214 can be a manufacturing plant at a worksite 210. In another example, an industrial site 214 can be a refinery. The worksite 210 can include a section for charging 216 (also referred to as “charging sites” 216). The charging sites 216 can include the chargers 106 and the machines 108.

The chargers 106 can be a device or a system that supplies electrical power for the charging of the battery of the machines 108 at the worksite. For example, a machine 108A can connect to a charger 106A to replenish the energy stored in the batteries of the machine 108A. Referring to FIG. 1 and FIG. 3, FIG. 3 depicts an example layout 300 of the worksite 210. The chargers 106 can be at a plurality of locations at the worksite. The chargers 106 can be near operation locations 104 or near machines 108. For example, a charger 106A may be located at or near operation location 104B, where the operation location 104B includes machine 104B. In another example, a charger 106B may be located near machines 108E and 108F, respectively. The chargers 106 can be or include a portable generator to move toward machines 108 which cannot reach the chargers 106. For example, a charger 106A can move towards a machine 108B (e.g., at operation location 104B) in the case where a battery pack within the machine 108A has depleted all of the stored energy.

The machines 108 can be at least one of charging machines, heavy equipment, electric machines, or heavy machines. Each machine 108 in the machines 108 can be designed to fulfill tasks corresponding to the operation locations 104 at the worksite. For example, at an excavation site the machines 108 can include bulldozers, excavators, or drill rigs, among others. Each machine 108 can include a transmission system, an engine system, a safety system, a communications system, or a hydraulic system among others. The machines 108 can use the communication system to transmit data and receive data or instructions to and from with the data processing system 102 over the network 101, respectively. For example, a machine 108 can send battery information and location information to a worksite controller 112. In another example, a charge/discharge controller 116 can transmit a charge command to a machine 108.

Referring back to FIG. 1 and FIG. 2, the worksite controller 112 can receive information indicative of the load metrics from the chargers 106. The chargers 106 can transmit the information over the network 101. In some embodiments, the chargers 106 may receive a request from the worksite controller 112. The request can trigger the chargers 106 to transmit the information to the worksite controller 112. For example, a worksite controller 112 can transmit a request to one or more chargers 106 and cause the one or more chargers 106 to transmit information to the worksite controller 112. The information can include active power of the chargers 106, reactive power of the chargers 106, voltage of the chargers 106, and the frequency associated with the chargers 106. The active power of the chargers 106 can correspond to power consumed by the chargers 106 from the electrical supply and convert the power to an appropriate form corresponding to the machines 108 at the chargers 106. The reactive power of the chargers 106 can correspond to electrical power which oscillates between a source and a load withing being consumed as active power. In some embodiments, the chargers 106 can periodically transmit such information to the worksite controller 112. In this regard, and in various embodiments, the chargers 106 can periodically, a-periodically, and/or on-demand transmit such information to the worksite controller 112.

The worksite controller 112 can receive information indicative of the load metrics from the microgrid controller 110. The microgrid controller 110 can transmit the information over the network 101. In some embodiments, similar to the chargers 106, the microgrid controller 110 may receive a request from the worksite controller 112. The request can trigger the microgrid controller 110 to transmit the information to the worksite controller 112. For example, a worksite controller 112 can transmit a request to a microgrid controller 110 and cause the microgrid controller 110 to transmit information to the worksite controller 112. The information from the microgrid controller 110 can provide insights regarding the demand and consumptions of electrical energy at the microgrid. In this regard, the microgrid controller 110 may provide such information on-demand (e.g., in response to a request from the worksite controller 112). In some embodiments, the microgrid controller 110 can periodically transmit such information to the worksite controller 112. In this regard, and in various embodiments, the microgrid controller 110 can periodically, aperiodically, and/or on-demand transmit such information to the worksite controller 112.

The load metrics can include one or more measurements corresponding to a demand in power at the worksite. The demand can indicate an increase or decrease in demand at the worksite. For example, a worksite may have a high demand. The high demand indicates there is a significant increase in power consumption at the worksite. In another example, a worksite may have a low demand. The low demand indicates that is a significant decrease in power consumption at the worksite. The increase in power can correspond to the use of the machines 108. For example, a first machine 108A, a second machine 108B, a third machine 108C, a fourth machine 108D, and a fifth machine 108E perform various activities (e.g., power consuming activities) at one or more locations at the worksite. Since there are multiple machines 108 active, the demand can increase during a period of time in which any number of such machines are actively charging (e.g., via the corresponding chargers 106). The one or more measurements can associate with the machines 108 during an activity associated with the worksite. The one or more measurements can include machine 108 utilization, machine 108 downtime, energy consumption, fuel consumption, worksite traffic, task completion time, and equipment health monitoring, among others. For example, a load metric can be a combination of machine 108 utilization, energy consumption of the machine 108, and machine 108 downtime. The load metrics can be stored in memory 118 for reference during a future time period.

The worksite controller 112 can identify metrics for a plurality of charging machines 108 to be charged at the worksite. The metrics can include one or more measurements corresponding to a supply of charge with the corresponding machine 108. The supply of charge can indicate the stored energy with a battery of the machine 108. For example, a machine 108A can have a supply of charge of 20%. In another example, a machine 108B can have a supply of charge of 90%. The one or more measurements can include energy consumption, operating hours, idle time, productivity, temperature metrics, and operator behavior, among others. For example, a metric can be a combination of energy consumption and operating hours for a machine 108A. In another example, the metric can be a combination of productivity, idle time, and energy consumption for a machine 108A.

The worksite controller 112 can receive battery metrics of the machines 108 from the machines 108 and/or from the chargers 106. For example, a machine 108A can transmit battery metrics to the worksite controller 112 via a network 101. In another example, a charger 106A can transmit battery metrics of a machine 108A at the charger 106A (e.g., the machine 108A connected to and being charged by the charger 106A) to the worksite controller 112. The battery metrics can include a state of charge, a state of health, a voltage, charging time, or safety parameters, among others. For example, battery metrics of a machine 108A can indicate the machine 108A has a state of charge of 80%. In another example, battery metrics of a machine 108A can indicate the machine 108A has a state of health of 3%. In yet another example, battery metrics of a machine 108A connected to a charger 106A can indicate the machine 108A has a charging time of 3 hours.

The worksite controller 112 can determine, for the machines 108, a charging rate for the machines 108 at the worksite. The charging rate can be determined for each machine 108 of the machines 108 (e.g., being currently charged or to be charged). For example, machine 108A can be a bulldozer with a charging rate of 100 A/h, whereas machine 108B can be an excavator with a charging rate of 85 A/h. Each machine 108 can have different battery characteristics. The battery characteristics of the machines 108 can include battery capacity, battery voltage, battery energy density, battery power density, or battery discharge rate, among others. For example, a machine 108A can have a battery capacity of 300 amp-hours (AH), whereas a machine 108B can have a battery capacity of 600 AH.

The charging rate can be based on the metrics at the worksite 210 and the load metrics of the microgrid 202. The system processor 114 may execute one or more functions to leverage aspects of the metrics and the load metrics to determine the charging rate. For example, a system processor 114 can use one or more functions to combine aspects of metrics and load metrics. The functions can extract energy consumption of the machines 108 from the metric and energy consumption of the microgrid 202 from the load metric.

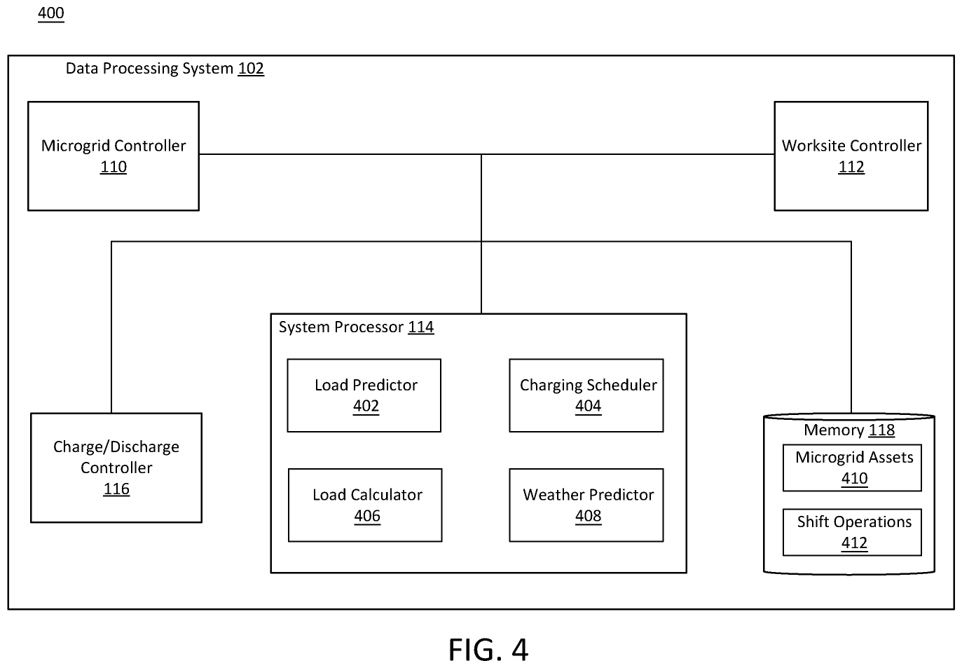

Referring to FIG. 1 and FIG. 4, FIG. 4 depicts an example 400 data processing system 102 for to implement worksite dynamic charging. The system processor 114 can execute the one or more functions using a load calculator 406 based on a signal from the worksite controller 112. The load calculator 406 can include and analyze and compute metrics and rates related to performance, efficiency, health, and charge for the machines 108. For example, the worksite controller 112 can send a signal including an identified metric for a plurality of charging machines 108A-N and a load metric from received information relating to the power source(s) 203 to the system processor 114. The system processor 114 can use the load calculator 406 to determine a charging rate for one or more machines 108. The system processor 114 can transmit the charging rate to the worksite controller 112. For example, after a load calculator 406 calculates a charging rate, a system processor 114 transmit the charging rate to a worksite controller 112.

The system processor 114 can include a load predictor 402. The load predictor 402 can generate one or more predictions for a load of the microgrid 202. For example, a load predictor 402 can use a load of a microgrid 202 from a previous time period or window (e.g., based on stored/maintained/accessed historic data) to predict the load of the microgrid 202 of a future time period. For instance, the load predictor 402 can identify a previous time period or window based on the current time, and identify or predict the load of the microgrid 202 based on or according to the historic load at the previous time period or window (along with any changes or delta accounted for under current operating conditions). The load predictor 402 can transmit the predicted load to the microgrid controller 110. For example, a load predictor 402 can send a predicted load for the microgrid 202 to a microgrid controller 110. The microgrid controller 110 can incorporate the predicted load into the load metrics of the microgrid 202 to determine the charging rate. The microgrid controller 110 may transmit the predicted load to the worksite controller 112.

The charging rate for the charging machines 108 can be based on a renewable availability from the microgrid 202. The renewable availability can correspond to the renewables 208 within the microgrid 202. The renewable availability can include at least one of wind speed, sunshine, force of tidal waves, or force of water in dams, among others. The renewable availability can correspond to the availability of the renewables 208. The renewable availability can change at various instances throughout the day. For example, a high renewable availability at the microgrid 202 can indicate a high number of renewables 208 at an instance of a day. The high number of renewables include a high availability of PV panels, gensets 206, or wind turbines. When the renewable availability is high, the microgrid 202 can rely on energy generated from the renewables 208 to charge the machines 108.

The charging rate can be based on an efficiency metric for the microgrid 202 to maximize efficiency of the microgrid 202. The microgrid controller 110 can generate the efficiency metric based on one or more microgrid assets 410 in memory 118. The microgrid assets 410 can communicate with the chargers 106 to receive updates for the microgrid assets 410. For example, a charger 106A can transmit microgrid assets 410 to the memory 118 throughout a day. The microgrid controller 110 can transmit updates to regarding the microgrid assets 410 to chargers 106. For example, a microgrid controller 110 can transmit updates to microgrid assets 410 to chargers 106. The microgrid assets 410 can include energy resources, energy storage, and control systems and the microgrid controller 110 can use elements of the microgrid assets 410 to generate the efficiency metric. For example, an efficiency metric can include data regarding energy resources and energy storage at a microgrid 202. The efficiency metric can correspond to a highest efficiency point of the microgrid assets 410 at the microgrid 202. The microgrid controller 110 can observe updates, changes, and data associated with the utilities 204, gensets 206, and renewable 208 to develop the microgrid assets 410 and generate the highest efficiency point.

The solution described herein may solve or implement an optimization function. The optimization function is used to optimize the efficiency metric generated from the microgrid controller 110 by utilizing an efficiency metric of the utilities 204, an efficiency metric of the gensets 206, and the efficiency metric of the renewables 208 as inputs for the optimization function. The maximization of the efficiency metric of the utilities 204, efficiency metric of the gensets 206, and the efficiency metric of the renewables 208 can directly improve the efficiency metric generated from the microgrid controller 110. Furthermore, the microgrid controller 110 can provide a recommendation or indication of a charging rate, use of microgrid assets 410, or power utilization, among others, to the worksite controller 112. Using the recommendation/indication from the microgrid controller 110, the worksite controller 112 can vary parameters corresponding to the charge/discharge rate and power quality of the chargers 106 and the machines 108 to ensure the worksite 210 is executing tasks close to the efficiency metric.

The worksite controller 112 can control the chargers 106 at the worksite 210, by transmitting one or more signals to the charge/discharge controller 116. For example, a worksite controller 112 can communicate with a charge/discharge controller 116 via one or more signals over the network 101. The one or more signals can include instructions, directions, or parameters, to cause the charge/discharge controller 116 to transmit a signal to the chargers 106. For example, one or more signals from the worksite controller 112 can instruct a charge/discharge controller 116 to adjust one or more parameters of the chargers 106. The parameters of the charger 106 can include amperage or voltage output, power output, charging mode, charging rate, and/or charge time, among others. For example, a charge/discharge controller 116 can adjust a charging rate of a charger 106A. In another example, a charge/discharge controller 116 can adjust a charging mode of a charger 106A. In yet another example, a charge/discharge controller 116 can adjust a power output of a charger 106A. The signal from the charge/discharge controller 116 can indicate whether to charge the machines 108 or discharge the machines 108. For example, a signal of a charge/discharge controller 116 indicate that a machine 108A needs to discharge to a microgrid 202 when at a charger 106A. In another example, a signal of a charge/discharge controller 116 indicate that a machine 108A needs to charge at a charger 106A.

The worksite controller 112 can control the chargers 106 based on the charging rate associated with a corresponding machine 108. The charging rate for the machines 108 can include a negative charging rate for the machines 108. The negative charging rate can indicate a rate that the machines 108 can discharge over time. For example, a machine 108A can have a negative charging rate by discharging a battery of the machine 108A during operation or use of the machine 108A. To control the chargers, the worksite controller 112 can transmit one or more signals to the charge/discharge controller 116. The one or more signals can indicate to charge the machine 108. For example, the worksite controller 112 can transmit a signal to the charge/discharge controller 116. In response to receiving the signal, the charge/discharge controller 116 can transmit the signal to a machine 108A to proceed to a charger 106A. In another example, the worksite controller 112 can transmit a signal to the charge/discharge controller 116. In response to receiving the signal, the charge/discharge controller 116 can transmit the signal to a machine 108A to operate, move to, or locate at operation location 104C until a time window. When the time window occurs the machine 108A can proceed to the charger 106B.

The system processor 114 can include at least one charging scheduler 404. The charging scheduler 404 can execute one or more instructions associated with the system processor 114. For example, a system processor 114 can instruct a charging scheduler 404 to generate a schedule for the worksite 210. The charging scheduler 404 can include one or more communication bus controllers to effect communication between the charging scheduler 404 and the other elements of the data processing system 102. For example, a charging scheduler 404 can communicate with memory 118. The charging scheduler 404 can access one or more shift operations 412 in memory 118. The memory 118 can include the one or more shift operations 412. The shift operations 412 can be a list, matrix, or data table corresponding to a plurality of tasks for the machines. For example, shift operations can indicate that machine 108A will complete an excavation task from 2:00 PM-4:00 PM. In another example, shift operations 412 can include table of all machines 108 at the worksite 210 and locations of the machines 108 throughout a work day. The system processor 114 can update the shift operations 412 based on a status of the machines 108. For example, a machine 108A can complete a task sooner than expected and notify a worksite controller 112 of the completion. The worksite controller 112 can transmit a signal to the system processor 114 to update a corresponding shift operation 412 for the machine 108A in memory 118.

The charge/discharge controller 116 can receive the schedule from the charging scheduler 404. For example, a charging scheduler 404 can generate a schedule based on the one or more shift operations 412. The charging scheduler 404 can transmit the schedule to a charge/discharge controller 116. The schedule can indicate one or more gaps in operation of the machines 108. The one or more gaps can be a period of time in which one or more machines 108 are not in use at the worksite 210. For example, a gap for a machine 108A can be from 11:00 AM-12:30 PM, whereas a gap for a machine 108B can be from 9:30 AM-2:00 PM. The load calculator 406 can use the one or more gaps for the generation of the charging rate. For example, a load calculator 406 can calculate a higher charging rate during one or more small gaps for a machine 108A. In another example, a load calculator 406 can calculate a lower charging rate during one or more larger gaps for a machine 108A.

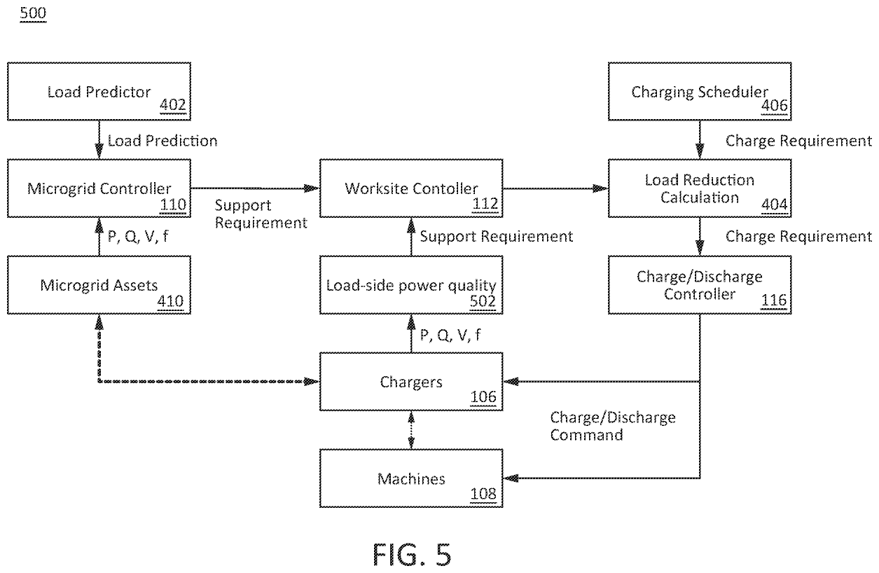

FIG. 5 depicts an example flow diagram 500 of communication for power quality support for the worksite 210 and microgrid 202. The flow diagram 500 can include all above defined components to facilitate worksite 210 dynamic charging. The microgrid controller 110 and the worksite controller 112 are configured to provide power quality support at the worksite 210. The power quality support enables the worksite 210 to dynamically charge/discharge the machines 108 based upon the changing layout 300 of the worksite 210. Thus, improving the productivity and efficiency at the worksite 210.

The load predictor 402 can transmit a first data signal including a load prediction to the microgrid controller 110. For ease of description, data signals can be electrical signals (e.g., analog signals, digital signals), wireless signals (e.g., radio waves), Serial Peripheral Interface (SPI) signals, Universal Serial Bus (USB) signals, among others. At the same time (or substantially the same/in parallel to), the microgrid assets 410 can transmit a second data signal including power, charge, voltage, or frequency information, among others, to the microgrid controller 110. The microgrid controller 110 can generate metrics (e.g., efficiency metric, load metrics, etc.) based on the information received from the microgrid assets 410. The microgrid controller 110 can transmit a third data signal including the metrics to the worksite controller 112. The worksite controller 112 can transmit a fourth data signal including the metrics to the load calculator 406. The load calculator 406 may leverage information from the charging scheduler 404 and the metrics to generate a charge requirement. A fifth data signal including the charge requirement can be transmitted from the system processor 114 to the charge/discharge controller 116.

The charge/discharge controller 116 can issue a charge command or a discharger command to the machines 108 and the chargers 106. In some arrangements the machines 108 can send battery metrics to the chargers 106 using Direct Current (DC). In some arrangements, the chargers 106 can send a charger availability to the machines 108 using DC power. The microgrid assets 410 can be sent to the chargers 106 to replenish the power of the chargers 106 during the workday using Alternating Current (AC) power. The chargers 106 can transmit the demand for power to the microgrid assets 410 of the microgrid 202 using AC power.

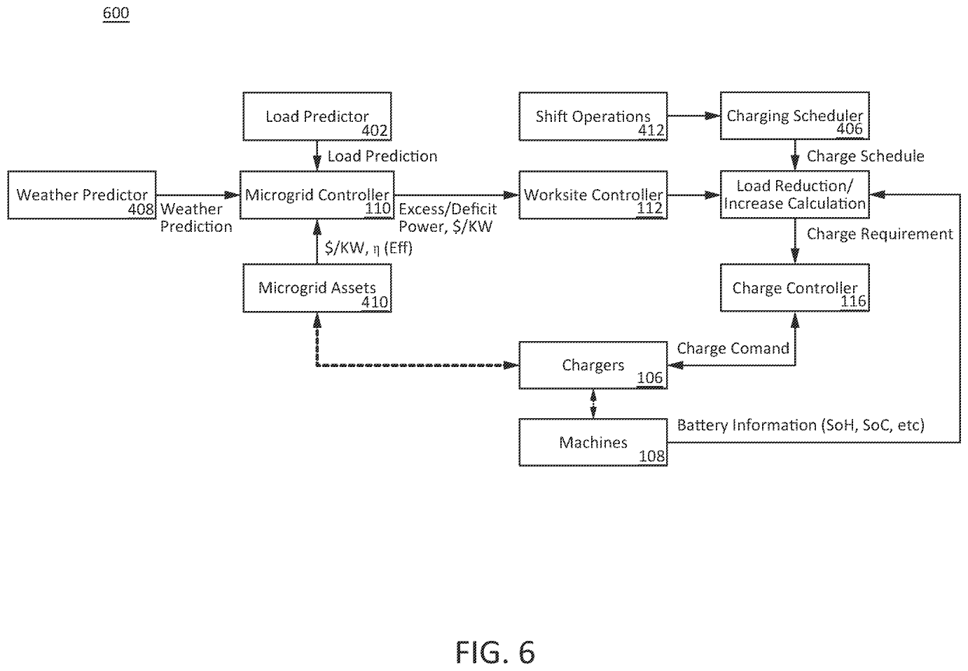

FIG. 6 depicts an example flow diagram 600 of communication for economic optimization for the worksite 210 and microgrid 202. The flow diagram 600 can include all above defined components to facilitate worksite 210 dynamic charging. The system processor 114 can include a weather predictor 408. The weather predictor 408 can predict weather forecast weather predictions near or at the worksite 210. In some embodiments, the weather predictor 408 may be or include a third-party resource, such as third-party weather application or forecasting resource. For example, a weather predictor can predict rainy/overcast/sunny weather at a worksite 210 on a particular day/date/range of time. The weather predictor 408 can transmit the predicted weather to the microgrid controller 110. For example, a weather predictor 408 can notify a microgrid controller 110 of rainy/overcast/sunny weather at a worksite 210. The microgrid controller 110 can adjust the load metrics based on the predicted weather (e.g., harsh weather, may require a higher load). For example, rainy weather can create mud at a worksite 210. The mud can create conditions difficult for machines 108 to navigate the worksite 210. Therefore, a microgrid controller 110 can increase load metrics accordingly. As another example, the microgrid controller 110 can adjust estimates for renewables 208 based on information received from the weather predictor 408. For instance, the microgrid controller 110 can increase an estimated output of power from renewables 208, based on a predicted sunny or windy day. The microgrid controller 110 and the worksite controller 112 are configured to provide economic optimization at the worksite 210 by adjusting load metrics and metrics according to the weather while maintaining power support quality. The economic optimization enables the worksite controller 112 to dynamically charge the machines 108 based upon the changing layout 300 and weather of the worksite 210. Thus, the systems and methods described herein may improve the productivity and efficiency at the worksite 210.

The load predictor 402 can transmit a first data signal including a load prediction to the microgrid controller 110. At the same time, the microgrid assets 410 can transmit a second data signal including power and current efficiency to the microgrid controller 110. The microgrid controller 110 can generate metrics (e.g., efficiency metric, load metrics, etc.) based on the load prediction, weather prediction, and the current efficiency of the worksite 210 and transmit a third data signal including the metrics to the worksite controller 112. The worksite controller 112 can transmit a fourth data signal including the metrics to the load calculator 406. The load calculator 406 may receive a fifth data signal to leverage a charge schedule from the charging scheduler 404 and the metrics to generate a charge requirement. The charge schedule can incorporate shift operations 412 of the one or more machines 108. The load calculator 406 can receive a sixth data signal including battery information (e.g., state of health, state of charge, voltage, etc.) from the machines 108. The charge requirement can be transmitted from the system processor 114 to the charge/discharge controller 116.

The charge/discharge controller 116 can issue a charge command, within a seventh data signal, to the chargers 106. In some arrangements the machines 108 can send battery metrics, using DC power, to the chargers 106. In some arrangements, the chargers 106 can send a charger availability, using DC power, to the machines 108. The microgrid assets 410 can be sent to the chargers 106, using AC power, to replenish the power of the chargers 106 during the workday. The chargers 106 can transmit the demand for power, using AC power, to the microgrid assets 410 of the microgrid 202.

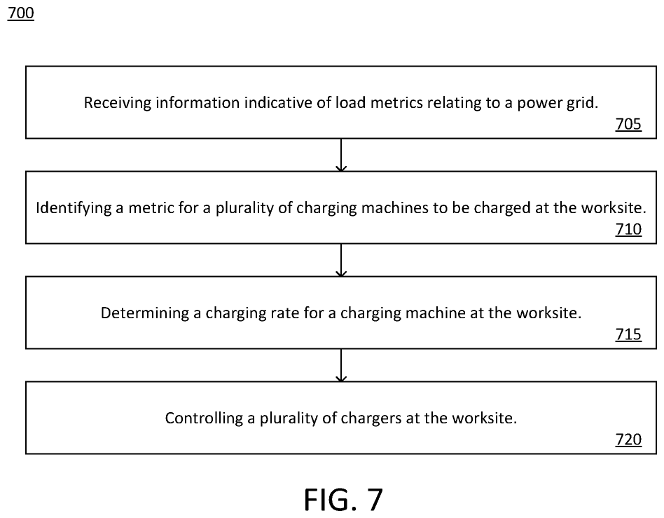

FIG. 7 depicts a 700 method to implement worksite dynamic charging for the worksite and microgrid. The method 700 can be performed by, using, or for system 100. The method 700 can include receiving information indicative of load metrics relating to a power grid at step 705. The method 700 can include identifying a metric for a plurality of charging machines to be charged at the worksite at step 710. The method 700 can include determining a charging rate for a charging machine at the worksite at step 715. The method 700 can include controlling a plurality of chargers at the worksite at step 720.

At step 705, the method 700 can include receiving, by one or more processors (e.g., system processor 114, microgrid controller 110, worksite controller 112, charge/discharge controller 116) information indicative of load metrics relating to a power grid (e.g., microgrid 202). The information indicative of the load metrics is received from the plurality of chargers (e.g., chargers 106A-N) and from a grid controller (microgrid controller 110) associated with the power grid. The load metrics can include one or more measurements corresponding to a demand in power at the worksite (e.g., worksite 210), wherein the demand indicating an increase in power at the worksite or a decrease in power at the worksite. For example, the worksite controller 112 can receive information indicative of load metrics from the system processor 114 to determine a charging rate for one or more machines.

At step 710, the method 700 can include identifying, by the one or more processors, a metric for a plurality of charging machines (e.g., machines 108A-N) to be charged at the worksite. The metric for the plurality of charging machines can include one or more measurements corresponding to a supply of charge with the corresponding charging machine. For example, a machine 108A can have a supply of charge of 20%. In another example, a machine 108B can have a supply of charge of 90%. The metric can be a value corresponding to an input for a load calculator (e.g., load calculator 406).

At step 715, the method 700 can include determining, by the one or more processors, for each charging machine of the plurality of charging machines, a charging rate for the charging machine at the worksite, according to the metrics and the load metrics of the power grid. The power grid can be a microgrid (e.g., microgrid 202). The method 700 can include receiving, by the one or more processors, battery metrics of the charging machine. The battery metrics can indicate at least one of a state of charge, a state of health, a voltage, charging time, or safety parameters. For example, the worksite controller can receive the battery metrics from the machines to provide to the load calculator. The method 700 can include determining, by the worksite controller, the charging rate for the charging machine at the worksite, based on a renewable availability (e.g., renewables 208) from the microgrid, wherein the renewable availability including at least one of wind turbines, photovoltaic (PV) panels, generator sets (e.g., gensets 206), or hydropower. The method 700 can include determining, by the worksite controller, the charging rate for the charging machine at the worksite, based on an efficiency metric for the microgrid to maximize the efficiency of the microgrid. The charging rate can include a negative charging rate. The method 700 can include discharging the corresponding charging machine to the power grid. For example, the machine can discharge at an operation location (e.g., operation location 104A-N) to reduce idle time of the machine and correspond to the negative charging rate.

At step 720, the method 700 can include controlling a plurality of chargers at the worksite. The method 700 can include receiving, by the one or more processors, a schedule, wherein the schedule indicating one or more gaps in operation of the charging machines. The method 700 can include transmitting, by the one or more processors of a worksite controller, one or more signals to a charge/discharge controller, to cause the charge/discharge controller to transmit one or more signals to the plurality of charging machines. The method 700 can include transmitting, by the charge/discharge controller, one or more signals to the plurality of chargers. The one or more signals indicating to charge the charging machine or discharge the charging machine. The charge/discharge controller can use the one or more signals to reduce an idle time of the machines. Thus, improving the productivity and efficiency of the worksite.

### INDUSTRIAL APPLICABILITY

The disclosed embodiments may be applicable to any dynamic charging based system or solution. For example, the disclosed embodiments may be applicable or applied to a machine, such as a bulldozer, a forklift, or any other type of machinery, a generator, a transformer, or any other type of electrical utility to be dynamically charged. The disclosed embodiments may be applicable to worksites which include various types of heavy machinery designed to execute tasks throughout the worksite to maximize efficiency. The disclosed worksite controller 112 described herein, may be provided to increase efficiency by generating proper charge and discharge rates for the heavy machinery. For example, because the worksite controller 112 receives information indicating charger availability and states of charge regarding the machines 108 and chargers 106, the worksite controller 112 can determine a charge/discharge rate for each respective machine. The charge/discharge rate may be dependent upon a charging schedule, state of charge of the machine 108, or microgrid assets 410, among others.

In various embodiments of the present solution, the worksite controller 112 may communicate with a microgrid controller 110 and a charge/discharge controller 116 to continuously maintain a peak efficiency at the worksite 210. By transmitting information regarding microgrid assets 410, power, voltage, frequency, charging schedules, and loads, from the various components of the system 100 (e.g., chargers 106, machines 108, microgrid controller 110, charge/discharge controller 116), the worksite controller 112 can continuously communicate with the machines 108 to maintain a peak efficiency at the worksite 210 and reduce an idle time of the machines 108.

In various embodiments of the present solution, the worksite controller 112 may leverage the various components of the system processor 114 to increase productivity at the worksite 210. For example, the system processor 114 can provide the worksite controller 112 with a plurality of load metrics corresponding to a load at a first machine 108A. By using the load metrics for the first machine 108A, the worksite controller 112 can provide a charging rate for the machine 108A based on changes of the load metrics while the machine 108A is executing task at the worksite 210. Furthermore, the worksite controller 112 can trigger the discharge/charge controller to discharge the machine 108A until a specific time period so the machine 108A can charge most effectively.

What is claimed is:

1. A method, comprising:
receiving, by one or more processors, information indicative of load metrics relating to a power grid;
identifying, by the one or more processors, metrics for a plurality of charging machines to be charged at a worksite;
determining, by the one or more processors, for each charging machine of the plurality of charging machines, a charging rate for the charging machine at the worksite, according to the metrics and the load metrics of the power grid; and
controlling, by the one or more processors, a plurality of chargers at the worksite, according to the charging rate associated with a corresponding charging machine.

2. The method of claim 1, wherein the information indicative of the load metrics is received from the plurality of chargers and from a grid controller associated with the power grid.

3. The method of claim 1, wherein the load metrics comprise one or more measurements corresponding to a demand in power at the worksite, wherein the demand indicating an increase in power at the worksite or a decrease in power at the worksite.

4. The method of claim 1, wherein the charging rate for the charging machine comprises a negative charging rate, and wherein the controlling the charger according to the negative charging rate comprises discharging the corresponding charging machine to the power grid.

5. The method of claim 1, wherein the metric for the plurality of charging machines comprises one or more measurements corresponding to a supply of charge with the corresponding charging machine.

6. The method of claim 1, wherein the power grid comprises a microgrid, wherein the one or more processors are of a worksite controller, and wherein controlling the plurality of chargers at the worksite comprises transmitting, by the one or more processors of the worksite controller, one or more signals to a charge/discharge controller, to cause the charge/discharge controller to transmit one or more signals to the plurality of charging machines.

7. The method of claim 6, further comprising transmitting, by the charge/discharge controller, one or more signals to the plurality of chargers, wherein the one or more signals indicating to charge the charging machine or discharge the charging machine.

8. The method of claim 6, further comprising:
determining, by the worksite controller, the charging rate for the charging machine at the worksite, based on a renewable availability from the microgrid, wherein the renewable availability including at least one of wind turbines, photovoltaic (PV) panels, generator sets, or hydropower; and
determining, by the worksite controller, the charging rate for the charging machine at the worksite, based on an efficiency metric for the microgrid to maximize the efficiency of the microgrid.

9. The method of claim 1, wherein determining a charging rate for the charging machine at the worksite further comprising receiving, by the one or more processors, battery metrics of the charging machine, wherein the battery metrics indicating at least one of a state of charge, a state of health, a voltage, charging time, or safety parameters.

10. The method of claim 1, wherein controlling a plurality of chargers at the worksite further comprises receiving, by the one or more processors, a schedule, wherein the schedule indicating one or more gaps in operation of the charging machines.

11. A data processing system comprising:
memory;
one or more processors configured to:
receive information indicative of load metrics relating to a power grid;
identify metrics for a plurality of charging machines to be charged at a worksite;
determine for each charging machine of the plurality of charging machines, a charging rate for the charging machine at the worksite, according to the metrics and the load metrics of the power grid; and
control a plurality of chargers at the worksite, according to the charging rate associated with a corresponding charging machine.

12. The data processing system of claim 11, wherein the information indicative of the load metrics is received from the plurality of chargers and from a grid controller associated with the power grid.

13. The data processing system of claim 11, wherein the load metrics comprise one or more measurements corresponding to a demand in power at the worksite, wherein the demand indicating an increase in power at the worksite or a decrease in power at the worksite.

14. The data processing system of claim 11, wherein the charging rate for the charging machine comprises a negative charging rate, and wherein, to control the charger according to the negative charging rate, the one or more processors are configured to discharge the corresponding charging machine to the power grid.

15. The data processing system of claim 11, wherein the metrics for the plurality of charging machines comprise one or more measurements corresponding to a supply of charge with the corresponding charging machine.

16. The data processing system of claim 11, wherein the grid comprises a microgrid, wherein the one or more processors are of a worksite controller, and wherein when controlling the plurality of chargers at the worksite, the one or more processors are configured to transmit one or more signals to a charge/discharge controller, to cause the charge/discharge controller to transmit one or more signals to the plurality of charging machines.

17. The data processing system of claim 16, wherein the charge/discharge controller further configured to transmit one or more signals to the plurality of chargers, wherein the one or more signals indicating to charge the charging machine or discharge the charging machine.

18. The data processing system of claim 16, wherein the one or more processors are further configured to:
determine the charging rate for the charging machine at the worksite, based on a renewable resource availability from the microgrid, wherein the renewable resource availability includes at least one of wind turbines, photovoltaic (PV) panels, generator sets, or hydropower; and
determine the charging rate for the charging machine at the worksite, based on an efficiency metric for the microgrid to maximize efficiency of the microgrid.

19. The data processing system of claim 11, wherein when determining a charging rate for the charging machine at the worksite, the one or more processors are configured to receive battery metrics of the charging machine, wherein the battery metrics indicate at least one of a state of charge, a state of health, a voltage, charging time, or safety parameters.

20. The data processing system of claim 11, wherein when controlling the plurality of chargers at the worksite, the one or more processors are further configured to receive a schedule, wherein the schedule indicates one or more gaps in operation of the charging machines, wherein the gap is a period of time in which the charging machine is not in use at the worksite.
